(19) United States
(12) Patent Application Publication
(10) Pub. No.: US 2008/0265771 A1
(43) Pub. Date: Oct. 30, 2008

(54) Plasma display panel

(76) Inventor: Tae-Joung Kweon, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/010,820

(22) Filed: Jan. 30, 2008

(30) Foreign Application Priority Data
Apr. 24, 2007 (KR) 10-2007-0039861

(51) Int. Cl. H01J 17/49

(52) U.S. Cl. 313/582

(57) ABSTRACT

A plasma display panel (PDP) includes a first substrate and a second substrate positioned to face each other to define a display area surrounded by a dummy area, a plurality of barrier ribs arranged between the first and second substrates defining a plurality of discharge cells, and discharge electrodes having address electrodes extending along a first direction and display electrodes extending along a second direction intersecting the first direction with dummy electrodes in the dummy area.

### BACKGROUND OF THE INVENTION

1. Field of the Invention

Example embodiments relate to a plasma display panel (PDP) and, more particularly, to a PDP having a uniform gap between rear and front substrates.

2. Description of the Related Art

PDP display devices typically realize images using visible light, e.g., red, green and blue light. The visible light may be generated when photoluminescent materials, e.g., phosphors, are stabilized after ultraviolet (UV) light, e.g., UV rays, excite the photoluminescent materials. UV light may be radiated by plasma that may be obtained via gas discharge.

PDPs may be classified into alternating current (AC) type PDPs or direct current (DC) type PDPs according to a type of driving voltage employed therein. In AC-type PDPs, there may be a front substrate and a rear substrate with discharge electrodes therebetween, barrier ribs between the front and rear substrates to define discharge cells and photoluminescent layers disposed on the barrier ribs within the discharge cells. In DC-type PDPs, however, the discharge electrodes may be exposed to a discharge space, allowing a DC to flow through the discharge space while voltage is applied.

The discharge electrodes of PDPs may include address electrodes arranged on the rear substrate, and sustain and scan electrodes arranged on the front substrate and intersecting the address electrodes. The address electrodes and the sustain and scan electrodes may be covered with a dielectric layer. Further, a protective layer may be formed on an inner surface of the dielectric layer to increase emission of secondary electrons.

The front and rear substrates are disposed in parallel and generally face each other. PDPs are generally manufactured by superposing a frit glass to inner surfaces (and along edges) of the front and rear substrates therebetween in order to form a sealed space, e.g., a display area (DPA) and a dummy area (DMA), between the front and rear substrates. The DMA is outside (or surrounds) the DPA. The DPA is an area for displaying images and includes discharge electrode, and the DMA is an area where no images are displayed and does not include any discharge electrodes.

Since there are no discharge electrodes in the DMA, the dielectric layer in the DMA may not be uniform with the dielectric layer in the DPA. Accordingly, gaps or spacings between the rear and front substrates may be larger in the DMA than in the DPA.

A problem that may arise from having non-uniform gaps or spacing between the rear and front substrates of a PDP is the creation of interferences, i.e., noise, in the displayed images.

### SUMMARY OF THE INVENTION

Example embodiments are therefore directed to a PDP, which substantially overcome one or more of the problems due to the limitations and disadvantages of the related art.

It is therefore a feature of example embodiments to provide a PDP having uniform gaps or spacing between rear and front substrates to diminish noise.

Another feature of example embodiments provides a PDP having uniform gaps or spacing in a DPA and a DMA to diminish noise.

At least one of the above and other features of example embodiments may provide a PDP including a first substrate and a second substrate positioned to face each other to define a display area surrounded by a dummy area, a plurality of barrier ribs arranged between the first and second substrates defining a plurality of discharge cells, and discharge electrodes having address electrodes extending along a first direction and display electrodes extending along a second direction that intersects the first direction, and dummy electrodes in the dummy area.

The dummy electrodes may extend along the second direction. The dummy electrodes may be arranged on the first substrate or the second substrate. The dummy electrodes may be a non-transparent material, e.g., a metal. A dielectric layer may cover the discharge electrodes and the dummy electrodes.

The PDP may further include a frit glass positioned away from the display area. The first and second substrates may be joined by the frit glass. The dummy area may be between the display area and the frit glass.

The discharge electrodes may further include transparent electrodes and bus electrodes. The transparent electrodes may be arranged on the second substrate corresponding to the discharge cells, and the bus electrodes may be connected to the transparent electrodes extending along the second direction.

The barrier ribs may further include first barrier rib members and a second barrier rib. The first barrier rib members may extend along the first direction, and second barrier rib members may extend along the second direction.

The PDP may further include a plurality of dummy barrier ribs to define a plurality of dummy discharge cells in the dummy area. The dummy barrier ribs may include first dummy barrier rib members extending along the first direction and second dummy barrier rib members extending along the second direction. Top surfaces of the second barrier rib members and the second dummy barrier rib members may face the second substrate, and photoluminescent layers may be arranged on the top surfaces of the second barrier rib members and the second dummy barrier rib members. The discharge electrodes and the dummy electrodes may be covered with a dielectric layer. The bus electrodes and the dummy electrodes may have substantially similar thicknesses and widths.

An area between the dielectric layer and the discharge cells in the display area may form a first gap, and an area between the dielectric layer and the dummy cells in the dummy area may form a second gap. The first gap in the display area and the second gap in the dummy area may be uniform.

### BRIEF DESCRIPTION OF THE DRAWINGS

The above and other features and advantages of the example embodiments will become more apparent to those of ordinary skill in the art by describing in detail example embodiments thereof with reference to the attached drawings, in which:

FIG. 1 illustrates a perspective view of a PDP according to an example embodiment;

FIG. 2 illustrates a partial plan view of a DPA and a DMA of a PDP according to an example embodiment;

FIG. 3 illustrates an exploded perspective view of a PDP according to an example embodiment;

FIG. 4 illustrates a top plan view of the PDP in FIG. 3;

FIG. 5 illustrates a cross-sectional view along the line V-V in FIG. 3;

FIG. 6 illustrates a cross-sectional view along the line VI-VI in FIG. 3; and

FIG. 7 illustrates a cross-section of a PDP having uniform gaps or spacings between the rear and front substrates of a PDP according to an example embodiment.

### DETAILED DESCRIPTION OF THE INVENTION

Korean Patent Application No. 10-2007-0039861 filed on Apr. 24, 2007, in the Korean Intellectual Property Office, and entitled: “Plasma Display Panel,” is incorporated by reference herein in its entirety.

Example embodiments will now be described more fully hereinafter with reference to the accompanying drawings; however, example embodiments may be embodied in different forms and should not be construed as limited to the embodiments set forth herein. Rather, these example embodiments are provided so that this disclosure will be thorough and complete, and will fully convey the scope of the invention to those skilled in the art.

In the figures, the dimensions of layers and regions may be exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer or substrate, it can be directly under, and one or more intervening layers may also be present. In addition, it will also be understood that when a layer is referred to as being “between” two layers or substrates, it can be the only layer between the two layers, or one or more intervening layers may also be present. Like reference numerals refer to like elements throughout.

As used herein, the expression “gap” is used to refer to any space that may exist between a protective layer and barrier ribs. The expression “spacing” is used interchangeably and is also used to refer to the space that may exist between the protective layer and the barrier ribs.

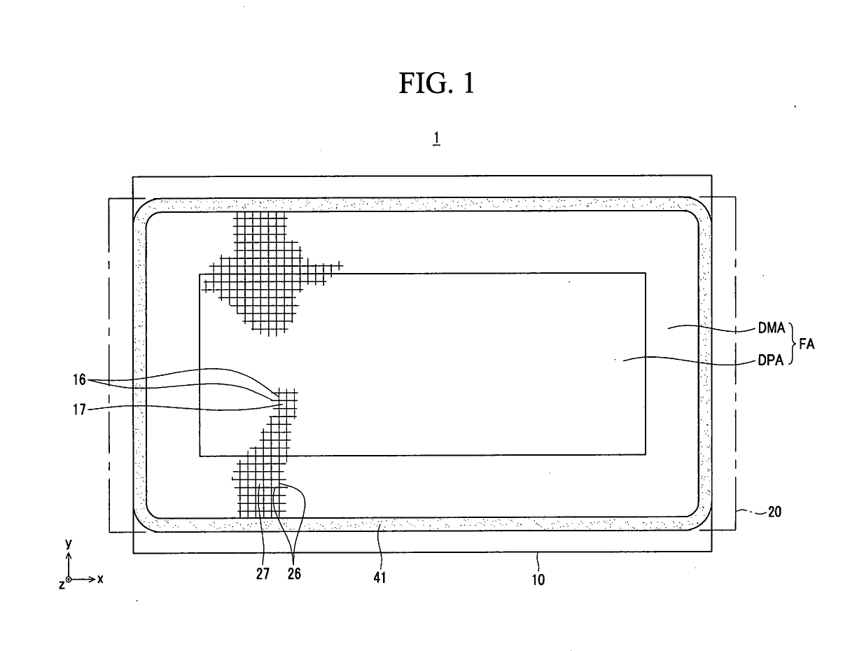

Referring to FIG. 1, a PDP 1 may include a first substrate 10 (hereinafter “rear substrate”) and a second substrate 20 (hereinafter “front substrate”) that may be superposed to each other. The PDP 1 may further include barrier ribs 16 arranged between the rear and front substrates 10 and 20 to define discharge cells 17. The rear and front substrates 10 and 20 may be disposed in parallel and may face each other. The rear and front substrates 10 and 20 may be formed of a transparent substrate, e.g., a soda lime glass, a semi-transmissible substrate, a reflective substrate, or a colored substrate.

A frit glass 41 may be applied to peripheral areas of inner surfaces of the rear and front substrates 10 and 20 therebetween so as to form a sealed space, e.g., a superposed area FA, between the rear and front substrates 10 and 20. In other words, the rear substrate 10 and the front substrate 20 may be joined with the glass frit 41 outside of the superposed area FA. The superposed area FA may be defined as a region where the rear substrate 10 and front substrate 20 are superposed to define a DPA and a DMA. The DMA may be outside (or surrounds) the DPA, i.e., an area between an edge of the DPA and the glass frit 41. The display area DPA may be an area where images are display, and the dummy area DMA may be an area where no images are displayed. The superposed area FA may include discharge cells 17 defined by the barrier ribs 16.

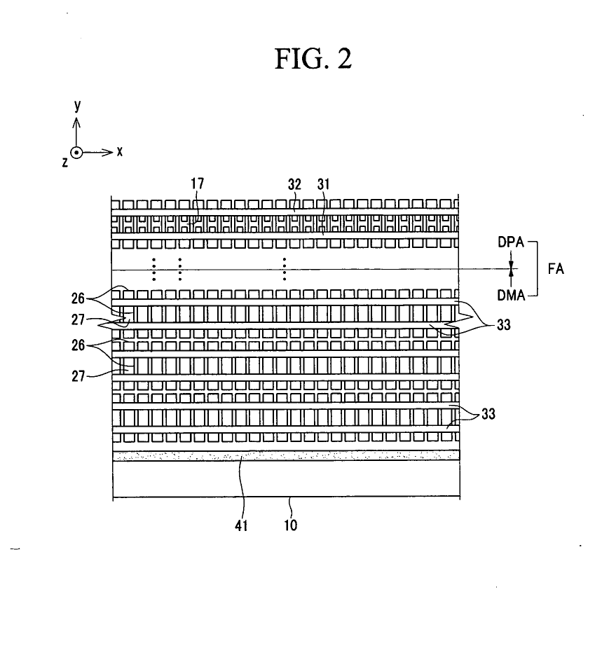

Referring to FIG. 2 through FIG. 4, the DPA may include address electrodes 11, which may extend along a first direction (e.g., y-axis direction) and display electrodes 30, which may extend along a second direction (e.g., x-axis direction) intersecting the first direction. The address electrodes 11 may further correspond to the discharge cells 17, which may be adjacent to each other along the first direction (e.g., y-axis direction). The adjacent address electrodes 11 may be arranged parallel to each other by a distance therebetween along the second direction (e.g., x-axis direction). The display electrodes 30 may include sustain electrodes 31 and scan electrodes 32, corresponding to the discharge cells 17. The sustain and scan electrodes 31 and 32 may be arranged to intersect the address electrodes 11.

The sustain electrodes 31 may function as electrodes for applying a sustain pulse that may be required for the sustain discharge. The scan electrodes 32 may function as electrodes for applying a reset pulse and a scan pulse. The address electrodes 11 may function as electrodes for applying an address pulse. In other words, in operating the PDP 1, a reset discharge may occur by a reset pulse, which may be applied to the scan electrodes 32 for a reset period. For an address period, following the reset period, an address discharge may take place by the scan pulse, which may be applied to the scan electrodes 32, and by the address pulse, which may be supplied to the address electrodes 11. For a sustain period, a sustain discharge may occur by the sustain pulse, which may be applied to the sustain and scan electrodes 31 and 32.

Further, the functions of the sustain electrodes 31, scan electrodes 32 and address electrodes 11 may vary according to a waveform of voltage, which may be applied to each discharge electrodes. Other functions may be implemented besides the ones mentioned above.

In order to display images, particular discharge cells 17 may be selected (turned on) by initiating the address discharge via an interaction of the address electrodes 11 and the scan electrodes 32. The selected discharge cells 17 may then be operated by the sustain discharge via an interaction of the sustain electrodes 31 and the scan electrodes 32.

Photoluminescent layers 19, e.g., phosphor layers, disposed in the discharge cells 17 may radiate visible light of the same or different colors. The photoluminescent layers 19 that radiate visible light of the same color may be adjacent to each other along the first direction (e.g., y-axis direction). The photoluminescent layers 19 that radiate visible light of different colors, e.g., red, green, and blue visible light, may be adjacent to each other along the second direction (e.g., x-axis direction). The photoluminescent layers 19 that radiate visible light of different colors may be alternately disposed in the discharge cells 17.

The DMA may further include dummy barrier ribs 26 and dummy electrodes 33. The dummy barrier ribs 26 may define dummy discharge cells 27, and the dummy electrodes 33 may correspond to each dummy discharge cells 27 (as shown in FIG. 2).

The address electrodes 11 may be disposed over the DPA and the DMA, extending along the first direction (e.g., y-axis direction). Accordingly, the address electrodes 11 and the dummy electrodes 33 may be disposed to intersect each other, corresponding to the dummy discharge cells 27.

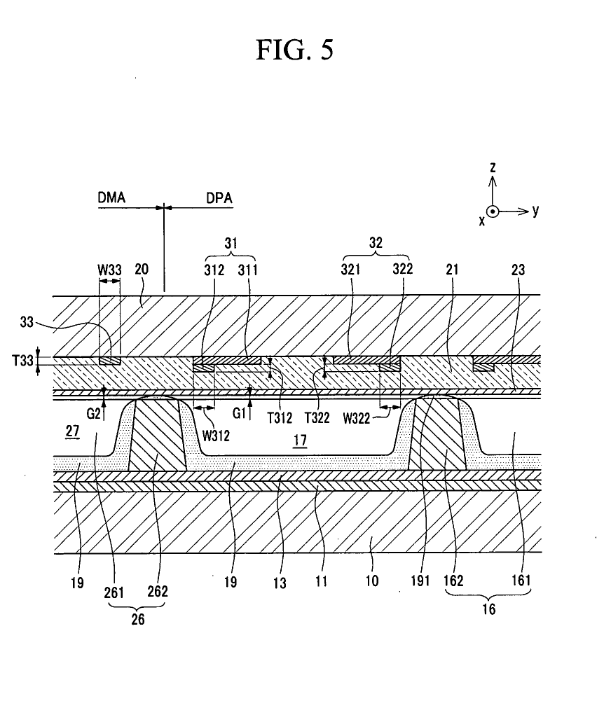

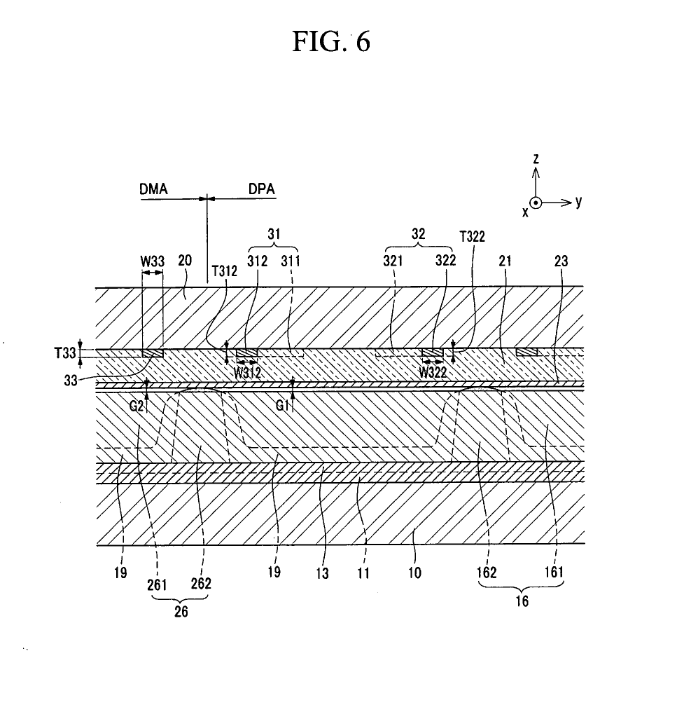

Referring to FIGS. 5 and 6, the address electrodes 11 may be covered with a first dielectric layer 13, which covers a top surface of the rear substrate 10. The first dielectric layer 13 may reduce and/or prevent cations or electrons from directly colliding with the address electrodes 11 and damaging the address electrodes 11. The first dielectric layer 13 may further form wall charges accumulating thereon during a discharge. The first dielectric layer 13 may be formed of a transparent dielectric material, e.g., a mixture of PbO—B₂O₃—SiO₂ having a high dielectric constant.

Further, because the address electrodes 11 may be disposed on the rear substrate 10, the address electrodes 11 may not obstruct a forward path of visible light. The address electrodes 11 may be made of nontransparent materials and highly conductive metal, e.g., silver (Ag).

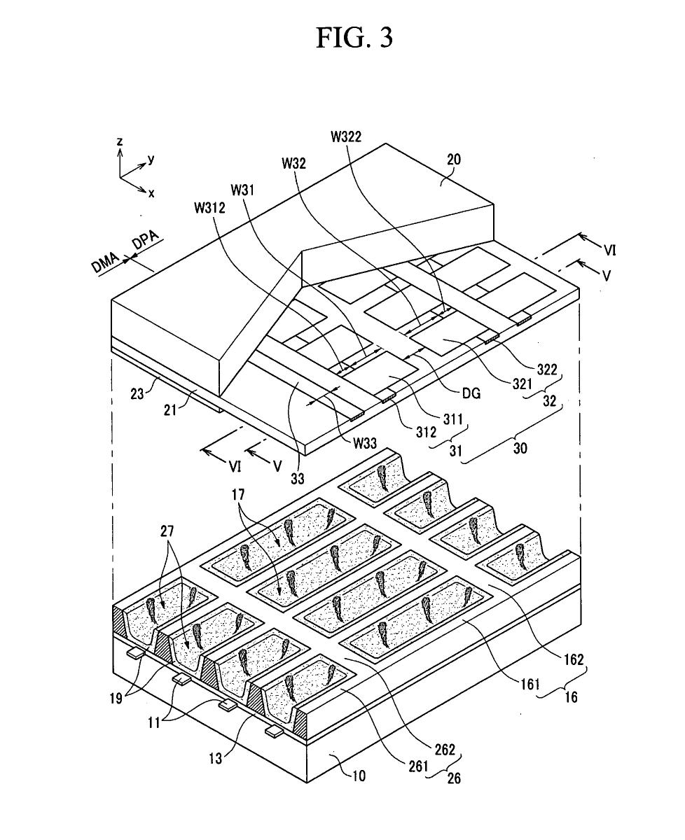

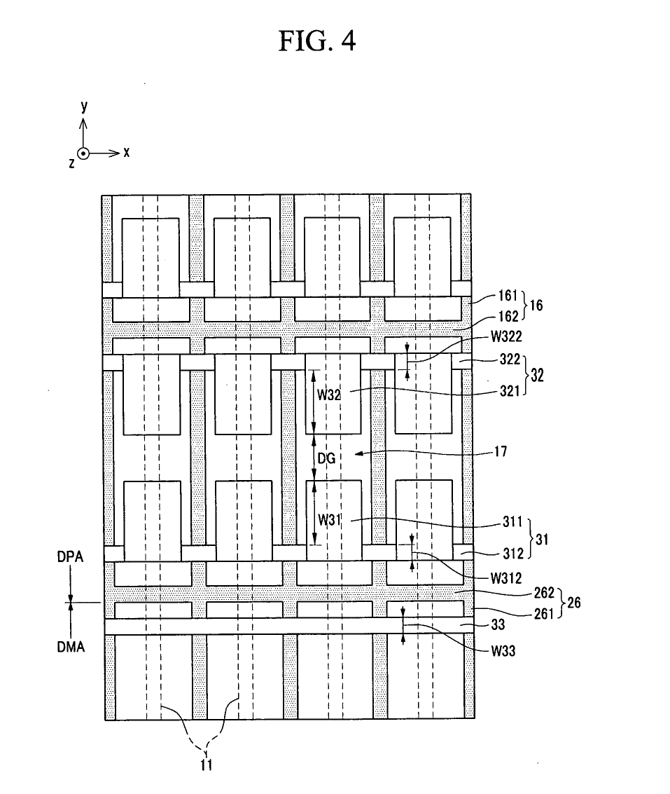

Referring again to FIGS. 3 and 4, a discharge gas, e.g., neon (Ne), xenon (Xe), helium (He), or a combination thereof, may fill the discharge cells 17. Then a voltage may be applied to the discharge gas to trigger UV light generation, followed by emission of visible light by the photoluminescent layers 19. The photoluminescent layers 19 may be disposed on any portion of inner surfaces of the discharge cells 17, e.g., an upper surface of the dielectric layer 13 and/or on side surfaces of the barrier ribs 16. The photoluminescent layers 19 may include a phosphor layer emitting red light, e.g., (Y,Gd)BO₃;Eu⁺³, a phosphor layer emitting green light, e.g., Zn₂SiO₄:Mn²⁺, and/or a phosphor layer emitting blue light, e.g., BaMgAl₁₀O₁₇:Eu²⁺.

The photoluminescent layer 19 may be formed by a dispensing method. For example, the photoluminescent layer 19 may be formed by dispensing phosphor pastes with a dispenser (not shown) moving along the first direction and then drying and firing the dispensed phosphor pastes. When the dispensing method is employed, the photoluminescent layer 19 may include a non-light emitting portion 191 (shown in FIG. 5). The non-light emitting portion 191 may include photoluminescent materials, e.g., phosphors, that may be dispensed on each top surface of second barrier rib members 162 and second dummy barrier rib members 262. As a result, the non-light emitting portion 191 may be formed in a first gap G1 (in the DPA) and a second gap G2 (in the DMA).

Similarly, the photoluminescent layer 19 may be disposed on the dummy barrier ribs 26 in the dummy discharge cells 27, and a discharge gas may fill the dummy discharge cells 27. The barrier ribs 16 may be disposed on the first dielectric layer 13 on the rear substrate 10, defining the discharge cells 17. The barrier ribs 16 may include first barrier rib members 161 and the second barrier rib members 162 that partition the discharge cells 17 into a matrix. As illustrated in FIG. 3, although the barrier ribs 16 defining the discharge cell 17 may be generally rectangular in shape, other suitable geometrical shapes, e.g., a polygon, a circle, or an oval, may be employed.

The first barrier rib members 161 may extend along the first direction (e.g., y-axis direction) and may be arranged apart from each other with a distance therebetween along the second direction (e.g., x-axis direction). The second barrier rib members 162 may extend along the first direction (e.g., x-axis direction) and may be arranged apart from each other along the first direction (e.g., y-axis direction) between the first barrier rib members 161.

Similarly, the dummy barrier ribs 26 may be arranged on the first dielectric layer 13 on the rear substrate 10 and define the dummy discharge cells 27. The dummy barrier ribs 26 may include first dummy barrier rib members 261 and second dummy barrier rib members 262 that partition the dummy discharge cells 27 into a matrix. The orientation of the dummy barrier ribs 26 may be similar to the orientation of the barrier rib 16.

The first dummy barrier rib members 261 may extend from the first barrier rib members 161 along the first direction (e.g., y-axis direction) and may be disposed apart from each other along the second direction (e.g., x-axis direction). The second dummy barrier rib members 262 may extend respectively along the second direction (e.g., x-axis direction) and may be disposed apart from each other along the first direction (e.g., y-axis direction) between the first dummy barrier rib members 261.

The sustain and scan electrodes 31 and 32, which may be arranged in the display area DPA, may be disposed on a bottom surface of the front substrate 20. The sustain and scan electrodes 31 and 32 may form a surface discharge structure that generates a gas discharge in the discharge cells 17. The sustain and scan electrodes 31 and 32 may further include transparent electrodes 311 and 321 and bus electrodes 312 and 322 to apply voltage signals thereto.

The transparent electrodes 311 and 321 may generate a surface discharge within the discharge cells 17. The transparent electrodes 311 and 321 may be made of a transparent conductive material, e.g., an indium tin oxide (ITO), for ensuring an adequate aperture ratio for the discharge cells 17. The transparent electrodes 311 and 321 may extend from edges of the discharge cells 17 toward a center along the first direction (e.g., y-axis direction). The transparent electrodes 311 and 321 may have widths W31 and W32, respectively, and may form a discharge gap DG in the center of each of the discharge cells 17.

The bus electrodes 312 and 322 may form a pattern and may be made of a highly conductive metallic material, e.g., a silver (Ag) paste, or may include chromium-cupper-chromium (Cr—Cu—Cr) layers with high conductivity, so as to compensate for a high electrical resistance of the transparent electrodes 311 and 321.

The bus electrodes 312 and 322 may be arranged respectively on the transparent electrodes 311 and 321 and may extend along the second direction (e.g., x-axis direction). When a voltage signal is applied to the bus electrodes 312 and 322, the voltage signal may be applied to the transparent electrodes 311 and 321 that are respectively connected to the bus electrodes 312 and 322.

The dummy electrodes 33, which may be disposed in the DMA, may also be arranged on a bottom surface of the front substrate 20; however, there may not be any voltage signal applied to the dummy electrodes 33. The dummy electrodes 33 may be made of a nontransparent material, similar to the material of the bus electrodes 312 and 322. Further, because the dummy electrodes 33 are not disposed in the DPA, the dummy electrodes 33 may not obstruct the displaying of images.

A second dielectric layer 21 may cover the sustain electrodes 31, the scan electrodes 32 and the dummy electrodes 33. The second dielectric layer 21 may further protect the sustain electrodes 31 and the scan electrodes 32 from accumulating wall charges during the discharge. The second dielectric layer 21 may be formed of a transparent dielectric material, e.g., a mixture of PbO—B₂O₃—SiO₂ having a high dielectric constant. The dielectric layer 21 may be disposed over the entire DPA. The second dielectric layer 21 may further be covered with a protective layer 23. The protective layer 23 may protect the second dielectric layer 21 and increase electron emissions during the discharge. The protective layer 23 may be made of, for example, but not limited to, a magnesium oxide (MgO).

Referring to FIG. 5, the first gap G1 may be formed between the protective layer 23 and the barrier ribs 16, and the second gap G2 may be formed between the protective layer 23 and the dummy barrier ribs 26. The dummy electrodes 33 and the bus electrodes 312 and 322 may have thicknesses of T33, T312 and T322, respectively. The dummy electrodes 33 and the bus electrodes 312 and 322 may have substantially similar thicknesses so long as the gap or spacing in the DMA is substantially avoided. Further, in the DMA, the second dielectric layer 21 may extend toward the dummy discharge cells 27 by a distance similarly corresponding to the thickness T33 of the dummy electrodes 33. Accordingly, the thickness of the second gap G2 may be similar to the first gap G1, e.g., the gaps G1 and G2 may be uniform.

Referring to FIG. 6, the dummy electrodes 33 and bus electrodes 312 and 322 may have widths of W33, W312 and W322, respectively. The dummy electrodes 33 and the bus electrodes 312 and 322 may have substantially similar widths so long as the gap or spacing in the DMA is substantially avoided. Further, in the DMA, the second dielectric layer 21 may extend by a distance similarly corresponding to the width W33 of the dummy electrodes 33. Accordingly, the thickness of the second gap G2 may be similar to the first gap G1, e.g., the gaps G1 and G2 may be uniform.

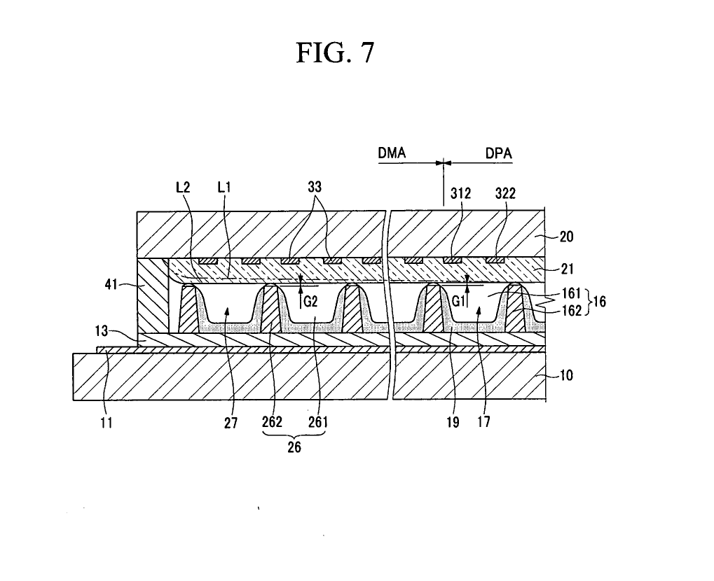

Referring to FIG. 7, the first gap G1 may be formed above the discharge cells 17 in the DPA, and the second gap G2 may be formed above the dummy discharge cells 27 in the DMA. For sake of clarity, illustration of the transparent electrodes 311 and 321 are omitted in FIG. 7.

As discussed above, the conventional PDP may not have any dummy electrodes formed in the DMA. As such, when no dummy electrodes are formed in the DMA, a bottom surface of the second dielectric layer 21 in the DMA may not be evenly aligned with a bottom surface of the second dielectric layer 21 in the DPA (as illustrated by imaginary line L1 of FIG. 7). In other words, the second gap G2 in the DMA may be larger than the first gap G1 in the DPA. This creates non-uniform gaps G1 and G2 and, thus, interference, e.g., noise, in the displayed images of the PDP 1.

Example embodiments provide dummy electrodes 33 in the DMA to compensate for the gap or spacing between the rear and front substrates 10 and 20. Further, the bottom surface of the second dielectric layer 21 in the DMA may be formed in an evenly manner (as illustrated by solid line L2 of FIG. 7), so as to reduce any spacing difference between the first and second gaps G1 and G2. Therefore, the gaps G1 and G2 may be uniform and noise in the displayed images of the PDP 1 may be reduced and/or prevented.

Example embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the example embodiments as set forth in the following claims.

What is claimed is:

1. A plasma display panel (PDP), comprising:
a first substrate and a second substrate positioned to face each other to define a display area and a dummy area, the dummy area surrounding the display area;
a plurality of barrier ribs arranged between the first and second substrates to define a plurality of discharge cells; and
discharge electrodes having address electrodes and display electrodes, the address electrodes extending along a first direction and the display electrodes extending along a second direction intersecting the first direction, and
dummy electrodes in the dummy area.

2. The PDP as claimed in claim 1, wherein the dummy electrodes extend along the second direction.

3. The PDP as claimed in claim 2, wherein the dummy electrodes are arranged on the first substrate.

4. The PDP as claimed in claim 2, wherein the dummy electrodes are arranged on the second substrate.

5. The PDP as claimed in claim 3, wherein the dummy electrodes comprise a non-transparent material.

6. The PDP as claimed in claim 5, wherein the non-transparent material is metal.

7. The PDP as claimed in claim 1, further comprising a dielectric layer, the dielectric layer covering the discharge electrodes and the dummy electrodes.

8. The PDP as claimed in claim 7, further comprising a frit glass positioned away from the display area, the first and second substrates being joined by the frit glass.

9. The PDP as claimed in claim 8, wherein the dummy area is between the display area and the frit glass.

10. The PDP as claimed in claim 1, wherein the discharge electrodes further comprise:
transparent electrodes arranged on the second substrate and corresponding to the plurality of discharge cells; and
bus electrodes connected to the transparent electrodes and extending along the second direction.

11. The PDP as claimed in claim 1, wherein the barrier ribs further comprise:
first barrier rib members extending along the first direction; and
second barrier rib members extending along the second direction.

12. The PDP as claimed in claim 11, further comprising a plurality of dummy barrier ribs to define a plurality of dummy discharge cells in the dummy area.

13. The PDP as claimed in claim 12, wherein the dummy barrier ribs further comprise:
first dummy barrier rib members extending along the first direction; and
second dummy barrier rib members extending along the second direction.

14. The PDP as claimed in claim 13, wherein top surfaces of the second barrier rib members and the second dummy barrier rib members face the second substrate, and photoluminescent layers are arranged on the top surfaces of the second barrier rib members and the second dummy barrier rib members.

15. The PDP as claimed in claim 14, wherein the discharge electrodes and the dummy electrodes are covered with a dielectric layer.

16. The PDP as claimed in claim 15, wherein the bus electrodes and the dummy electrodes have substantially similar thicknesses.

17. The PDP as claimed in claim 16, wherein the bus electrodes and the dummy electrodes have substantially similar widths.

18. The PDP as claimed in claim 17, wherein a first gap is formed between the dielectric layer and the barrier ribs in the display area, and a second gap is formed between the dielectric layer and the dummy barrier ribs in the dummy area.

19. The PDP as claimed in claim 18, wherein the first gap in the display area and the second gap in the dummy area are uniform.
